(19) United States
(12) Patent Application Publication
(10) Pub. No.: US 2008/0022813 A1
(43) Pub. Date: Jan. 31, 2008

(54) Firefighter Tool

(76) Inventor: Terry C. Farrell, Conneaut Lake, PA (US)

Correspondence Address: LACKENBACH SIEGEL, LLP, LACKENBACH SIEGEL BUILDING, 1 CHASE ROAD, SCARSDALE, NY, 10583, US

(21) Appl. No.: 11/857,010

(22) Filed: Sep. 18, 2007

Related U.S. Application Data
(63) Continuation-in-part of application No. 11/493,682, filed on Jul. 26, 2006.

(51) Int. Cl. B25B 13/48

(52) U.S. Cl. 81/125.1; 7/138

(57) ABSTRACT

A firefighter tool has pivotably connected handles and jaws, and one handle has an outer generally sinusoidal surface and the handle end is formed with a hook facingly disposed to the generally sinusoidal surface. The handles open fully so that the user grips the other handle and the sinusoidal surface hook alternately operably contactingly engages differently sized and configured fire hose couplings.

### PRIOR RELATED APPLICATION

This application is a continuation-in-part of application Ser. No. 11/493,682, filed Jul. 26, 2006, and claims priority thereto and incorporates the priority application herein in its entirety by reference thereto.

### BACKGROUND OF THE INVENTION

1. Field of the Invention

This invention relates to hand tools. This invention specifically relates to hand tools having multiple functionalities. This invention more specifically relates to a firefighter tool having multiple functionalities.

2. Background of the Prior Art

Firefighter tools having multiple functions are disclosed in USD210,141, granted Feb. 13, 1968 to Woods; USD226,162, granted Jan. 30, 1973 to Zlayele, Jr., USD233,405, granted Oct. 29, 1974 to Frey; USD244,252, granted May 10, 1997 to Ardis; USD281,216, granted Nov. 5, 1985 to Cutliff, Jr, et al.; USD 329,972, granted Oct. 6, 1992 to Calvagno; U.S. Pat. No. 1,561,647, granted Nov. 17, 1925 to Johnson; U.S. Pat. No. 2,360,163, granted Oct. 10, 1944 to Sadler; U.S. Pat. No. 3,599,255 granted Oct. 21, 1968 to Carroll, Sr.; U.S. Pat. No. 3,949,439, granted Apr. 13, 1976 to Ardis; U.S. Pat. No. 4,287,623, granted Sep. 8, 1981 to Tarran; U.S. Pat. No. 4,597,123, granted Jul. 1, 1986 to Cobe, Jr.; U.S. Pat. No. 4,646,378, granted Mar. 3, 1987 to Borden; U.S. Pat. No. 5,105,493, granted Apr. 21, 1992 to Lugtenaar; U.S. Pat. No. 5,428,853, granted Jul. 4, 1995 to Menke; U.S. Pat. No. 6,308,355, granted Oct. 30, 2001 to McMillan et al.; U.S. Pat. No. 6,397,420, granted Jun. 4, 2002 to Roxton; U.S. Pat. No. 6,899,001, granted May 31, 2005 to Sanders et al.; and US Publication 2004/0261188, published Dec. 30, 2004 to Mathis.

The wrench art generally disclosed a unitary member and hook for effectively engaging one specifically sized coupling as disclosed in USD138,515 to Hardy, USD337,492 to Ryan et al. and U.S. Pat. No. 6,705,182 to Bennett.

The firefighter wrench art was directed to a movable or displaceable hook or other movable element in order to engage diversely sized couplings as disclosed in U.S. Pat. No. 6,298,754 to Brown, U.S. Pat. No. 1,936,359 to Huthsing et al. U.S. Pat. No. 5,428,853 to Menke et al., U.S. Pat. No. 5,247,715 to Nishiguchi.

Referring specifically to FIG. 1 (Prior Art), there is shown the multi-purpose rescue tool disclosed in US Publication No. 2006/015674, published Jul. 20, 2006 to Gillingham (“the Gillingham tool”). The Gillingham tool 1 includes a handle 8 with a planar contact surface 2 for engaging small sized fire hose couplings (not shown), wherein there is line contact between the cylindrical surface of the coupling and the handle planar contact surface 2. The Gillingham hook end 3 is curved with a terminal sharp edge which has a limited range of utility the Gillingham tool is only operable with the handles in the closed position. This is because the handles open to only a limited degree, and the arm 4 and cutter 5 disposed in the inside 6 of handle 7 prevent a user from griping the handle 7.

The art desires a firefighter tool that is operable with diversely sized and configured couplings, and wherein a large force may be asserted to readily and effectively rotate and uncouple the diversely sized and configured couplings, particularly where the couplings are seized tight.

The present invention provides a firefighter tool that meets the foregoing art needs.

### SUMMARY OF THE INVENTION

The invention in one principal aspect is a tool member that is a wrench construction having the combination of a generally sinusoidal curvature or surface and a hook disposed at an end of the member and in facing disposition to the generally sinusoidal surface. The combination of the generally sinusoidal surface and the facingly disposed hook permits a user to variously operably engage diversely sized and configured couplings. The present tool engages fire hose couplings of from about 1½″ to 5″ in diameter having from 2 to 6 lugs or ears. The tool member, in one embodiment, may be of one-piece unitary construction.

The invention, in another respect, is a tool that has two members, and each member has a distal end formed with a jaw, and a proximate end formed with one or more grip portions, and a pivot member disposed between the respective ends, so that as pliers the handles open and close the jaws and one member having the afore-discussed combination of the generally sinusoidal curvature or surface and the facingly disposed hook formed at the proximate end of the one member. The user may employ the wrench with the handles opened or closed. The pliers are configured to open so that the fully opened handles subtend an angle of at least about 70°. The user in one mode of operation grips one handle and exerts a large force, through bearing surfaces on the opened jaws, to the wrench end generally sinusoidal surface and to the hook to quickly open seized fire hose couplings.

The sinusoidal curvature or surface includes a convex surface and a contiguous concave surface. The radii of the convex and concave surfaces are about equal. The concave surface is disposed more adjacent to the proximate end of one member than the distal end. The inflection or transition surface disposed between the concave and convex curvatures is generally the contact engagement surface. With the wrench sinusoidal surface engaging each respective coupling cylindrical surface, there is, in contradistinction to a line contact between the coupling cylindrical surface and of the wrench contact surface of the Gillingham tool, an engagement surface area.

The present hook construction extends from the proximate end to the distal end. The hook distal portion or end face has a generally rectilinear construction and a planar angled face. This hook construction provides an operable bearing surface for diversely sized and configured lugs or ears that extend radially outwardly from the coupling cylindrical surface.

The present firefighter tool is diversely operable with diversely sized and configured fire hose couplings. In use, the present firefighter tool exerts a large torque force and readily rotates and uncouples couplings that are seized tight.

### BRIEF DESCRIPTION OF THE DRAWINGS

FIG. 1. is a proximate end perspective view of a PRIOR ART multi-purpose rescue tool;

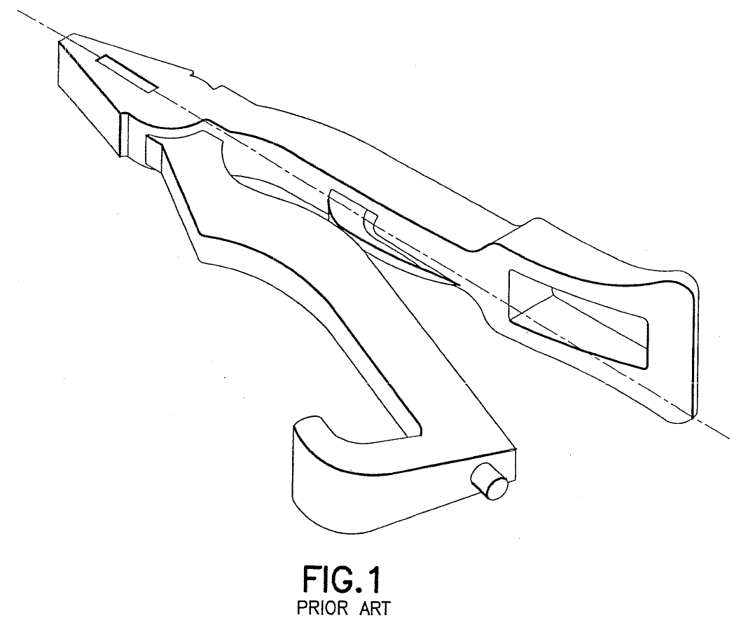

FIG. 2. is a front elevational view of the firefighter tool of the present invention in the fully opened position;

FIG. 3. is a front elevational view of the firefighter tool of FIG. 2 in the fully closed position;

FIG. 4. is a greatly enlarged fragmentary view of the pivot assembly as shown in FIG. 2;

FIG. 5A. is a front elevational view of the firefighter tool of FIG. 2 in use with a fire hose coupling of a first size;

FIG. 5B. is a front elevational view of the firefighter tool of FIG. 2 in use with a fire hose coupling of a second size;

FIG. 5C. is a front elevational view of the firefighter tool of FIG. 2 in use with a fire hose coupling of a third size;

FIG. 6. shows the firefighter tool as in FIG. 5B being operably equipped by the firefighter;

FIG. 7. shows the firefighter tool as in FIG. 3 being operably gripped by the firefighter;

FIG. 8. shows an alternate embodiment of the firefighter tool, alternatively engaging a 3″ coupling with a 5″ coupling; and

FIG. 9. is the firefighter tool of FIG. 2 operably engaging a 3″ reducing coupling of a 5″ coupling.

### DESCRIPTION OF THE INVENTION

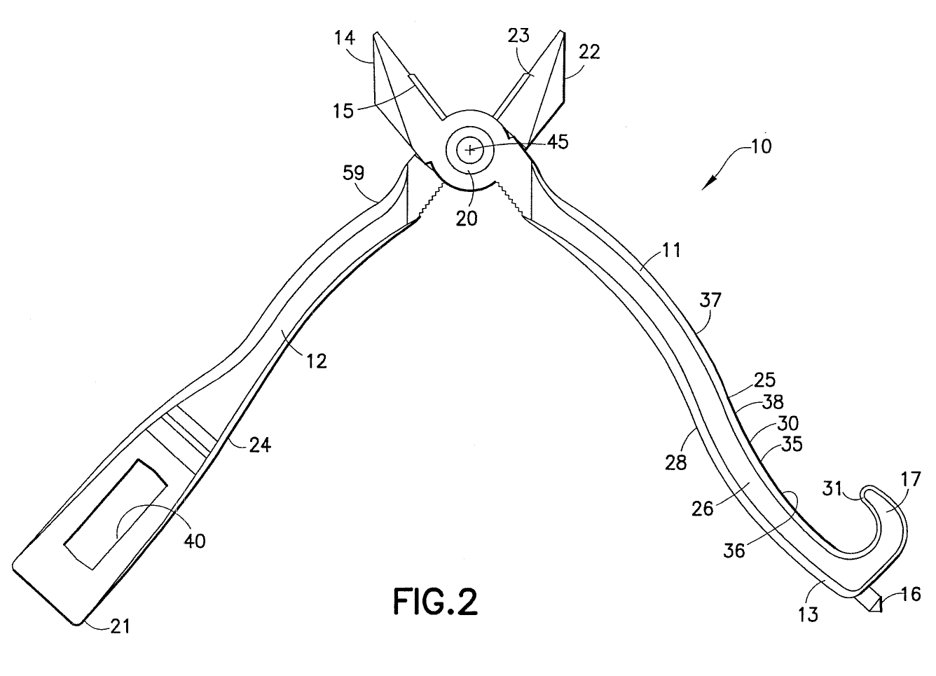

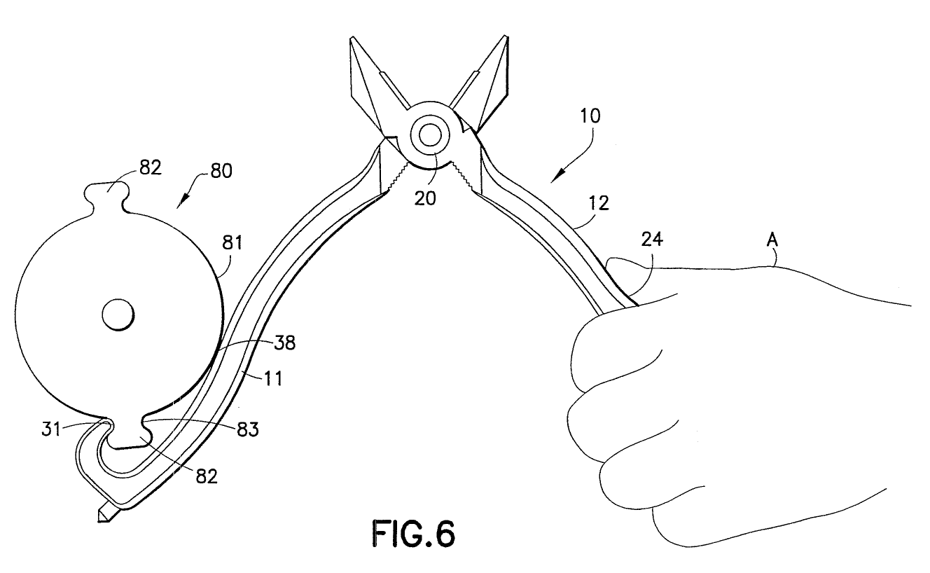

Referring to FIGS. 2-7 and 9, there is shown firefighter tool 10. Tool 10 includes members 11 and 12, pivotally connected by pivot member 20. Member 11 has a proximate end 13 and a distal end 14. Distal end 14 includes jaw 15. Proximate end 13 includes proximately disposed pin 16 and distally extending hook 17, and hook end 31 for purposes hereinafter appearing. Member 12 has a proximate end 21 and a distal end 22. Distal end 22 includes jaw 23. Member 12 includes handle portion 24. Member 11 includes handle portion 25 (see e.g., FIG. 6). Jaws 15 and 23 pivotably open and close with the movement of the handle portions 24 and 25, by pivot member 20.

Handle 25 is formed with a front surface 26, a rear surface 27, an inner surface 28 and an outer surface 30. Outer surface 30 is specifically configured in a generally sinusoidal curvature 35. Surface curvature 35 includes a proximately disposed concave portion 36, a convex portion 37, and an intermediate or transitional portion 38, for purposes hereinafter appearing. The respective radii of curvatures 36 and 37 are about equal. Handle 24 includes a wedge 39 formed at proximate end 21. A through hole wrench 40 is disposed between handle portion 24 and wedge 39. Through hole 40 is a parallel disposition with pivot axis 45 of pivot member 20.

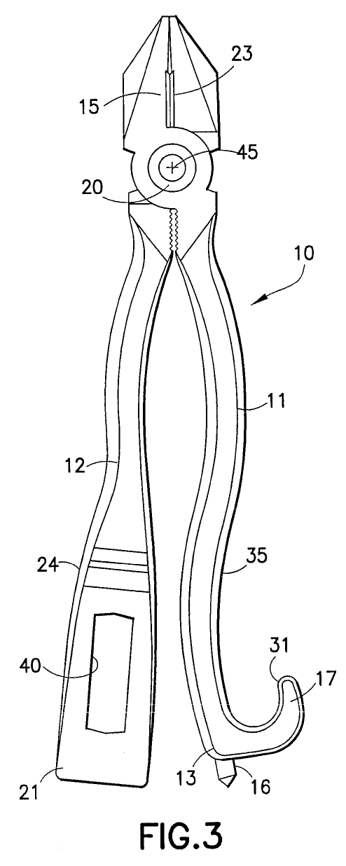

Referring specifically to FIG. 3, there is shown tool 10 in the fully closed position. Jaws 15 and 23 are contactingly engaged. A user (not shown) can grip closed jaws 15 and 23 and use wedge 21 or wrench 40 of member 12. The user (not shown) can otherwise grip closed jaws 15 and 23 and use configured surface 35 in cooperation with hook end 31 for uncoupling a fire hose coupling, as more fully discussed hereinafter.

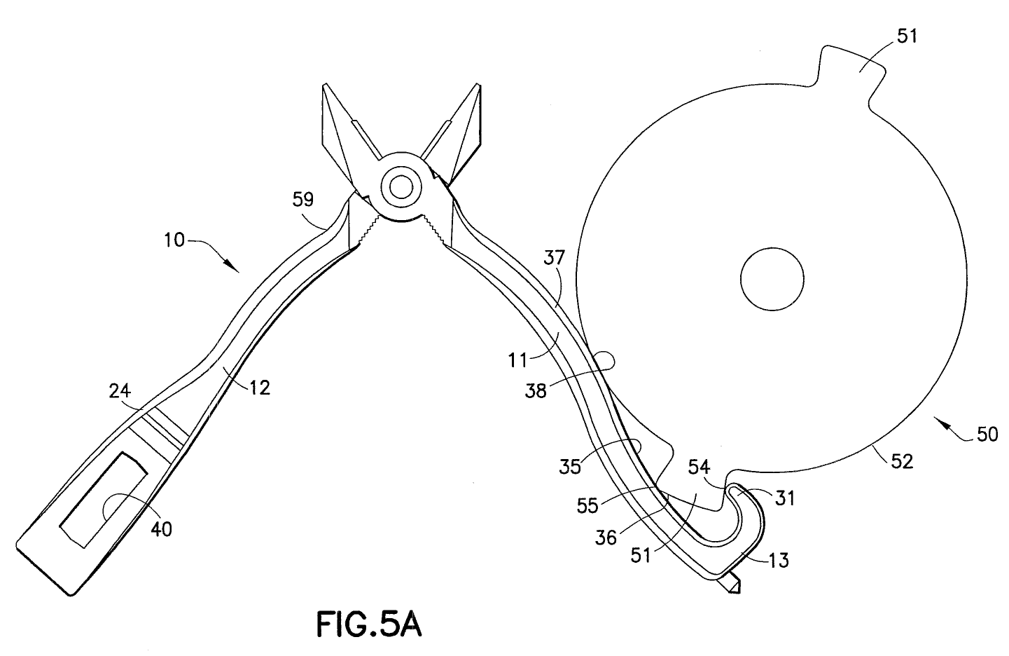

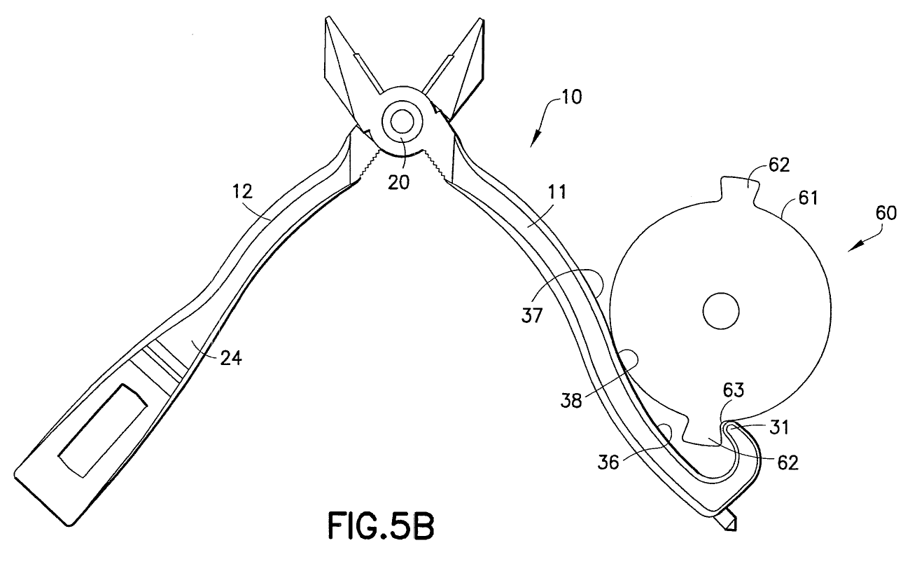

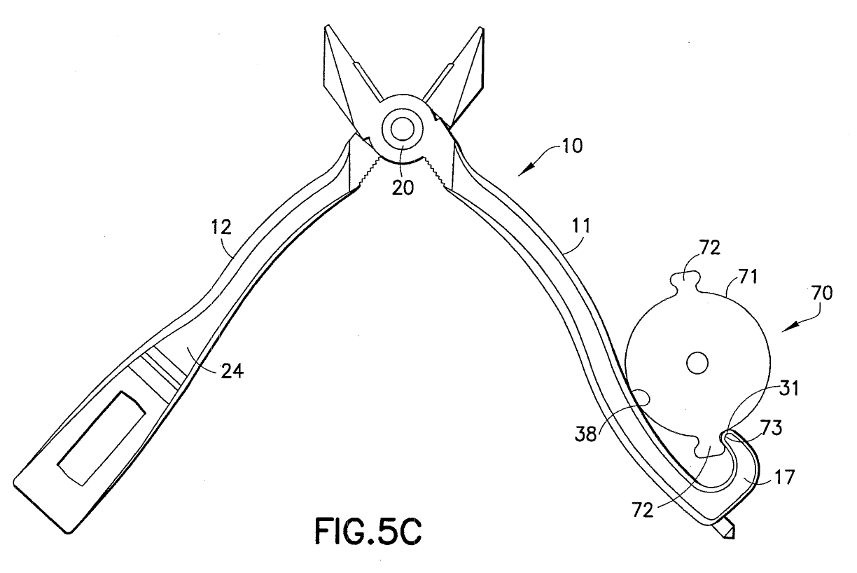

Referring specifically to FIG. 5A there is shown firefighter tool 10 in the fully opened position. Tool 10 is shown in operable engagement with a 5″ fire hose coupling 50. Coupling 50 has 2 radially extending lugs 51 (typical), and cylindrical surface 52. It is understood that fire hose couplings are differently diametrically sized with differently configured and numbered lugs.

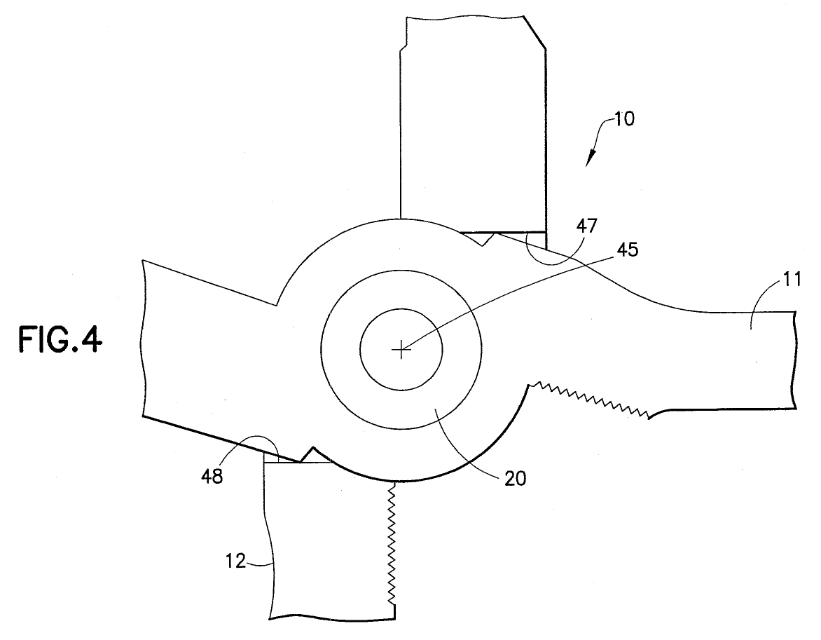

The user (not shown) grips handle 24 of member 12 and causes hook end 31 in combination with facingly opposed surface 35 to engage coupling 50 (FIG. 5A). With respect to the 5″ coupling, hook end 31 engages lug recess 54, concave surface 36 lug engages corner edge 55, and transitional surface 38 engages coupling cylindrical surface 52 (FIG. 5A). The user then exerts an upward force on member 12, which force is transmitted through bearing surfaces 47 and 48 (FIG. 4) to member 11. The exerted force is in turn transferred through surfaces 38 and 36, and hook end 31 to coupling 50 to rotate (counter clockwise as shown in FIG. 5A) to uncouple coupling 50.

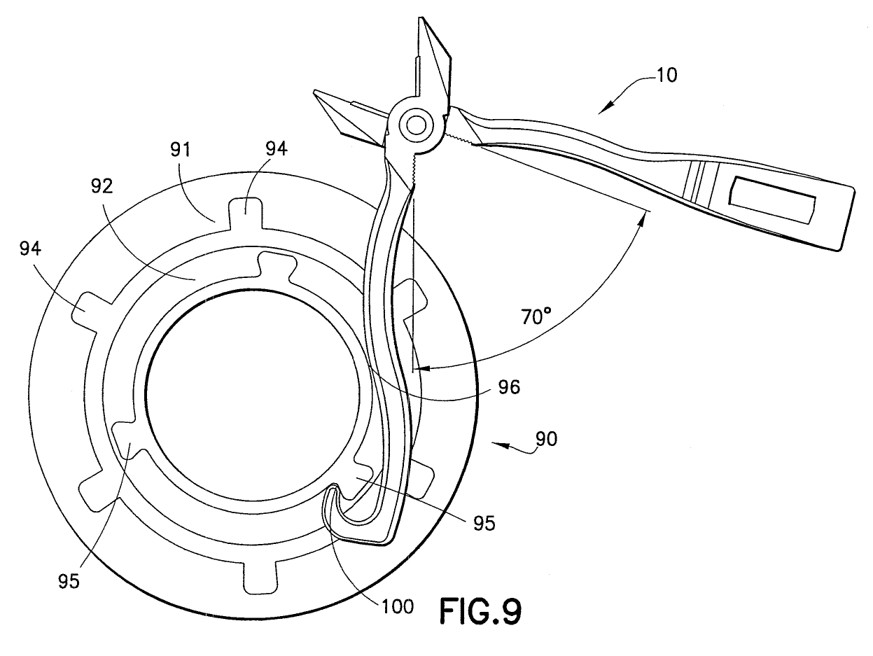

The present construction is designed to cause member 11 and 12 to open to at least about a 70° angle (FIG. 9) when operated in the fully opened mode. This large angular disposition in combination with the force transfer bearing surfaces 47 and 48 cause a substantial torque to be exerted on the coupling. It has been found that when a 250 lb. force is exerted on handle 24 in both the upward and sideward directions a resultant 354 lb. force is generated at 45°. Further, a Von Mises (WCS) stress analysis reveals that the area of highest stress is not in the pivot member 20 area but rather at portion 59 of member 12. The pivot member 20 and bearing surfaces 47 and 48 were found to be surprisingly under low stress. This construction permits an effective torque force to be generated without damage or deformation in and to the pivot member area engaged surfaces.

Referring specifically to FIG. 5B, there is shown tool 10 in operable engagement with 3″ coupling 60. Coupling 60 includes cylindrical surface 61 and lugs 62. Lug 62 (typical) and cylindrical surface 61 converge at recess 63. The user grips handle 24 and causes hook end tip 31 to be inserted in recess 63, with transitional surface 38 contactingly engaged with coupling cylindrical surface 61. The user then exerts an upward force on handle 24 to generate a resultant torque force on coupling 60.

Referring specifically to FIG. 5C, there is shown tool 10 in operable engagement with 1½″-2″ coupling 70. Coupling 70 includes cylindrical surface 71 and lugs 72. Lug 72 (typical) and cylindrical surface 71 converge at recess 73. The user grips handle 24 and causes hook end 31 to fit into recess 73 and transitional surface 38 to contactingly engage cylindrical surface 71. The user then, in a likewise manner, exerts an upward force to generate a resultant torque force on coupling 70.

Referring specifically to FIG. 6, there is shown a reverse side elevational view of tool 10 in operable engagement with 3″ coupling 80. Coupling 80 differs from coupling 70 in that the lugs 82 are differently configured than lugs 72. The user A causes hook tip 31 to be inserted in recess 83 and transitional surface 38 to contactingly engage cylindrical surface 81. A torque force is then exerted in the above-described manner. FIGS. 5A-5C and 6 demonstrate the fully opened mode tool 10 in operable engagement with differently sized and configured fire hose couplings. The present invention provides a universal tool for readily uncoupling diversely sized and configured fire hose couplings.

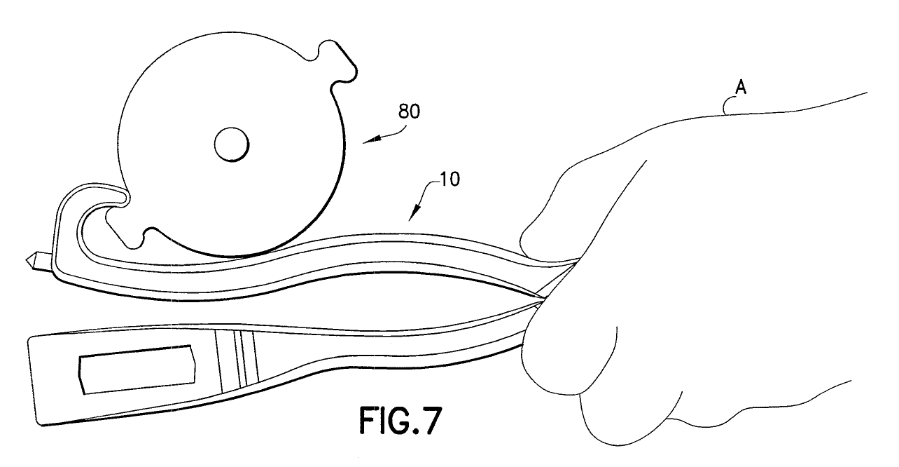

Referring specifically to FIG. 7 there is shown tool 10 in the fully closed mode in operable engagement with coupling 80. The user A grips the surfaces formed by closed jaws 15 and 23, and exerts a downward force to uncouple coupling 80.

Referring specifically to FIG. 9, there is shown tool 10 in the fully opened mode in operable engagement with a standard 5″ to 3″ reduction coupling 90. Reduction coupling 90 is a one-piece unitary forge metal or molded impact resin construction, as is well known in the firefighter tool art. Reduction coupling 90 is formed with a rearwardly disposed 5″ coupling engagement portion 91, and a forwardly disposed 3″ coupling 92. Portion 91 is designed to fit over or cover standard 5″ couplings. The six lug covers 94 engage two or more of the respective 5″ coupling lugs. In this manner of construction, the 5″ coupling is reduced to a 3″ coupling. The resultant 3″ coupling is designed with 3 lugs 95. Tool 10 engages one lug 95 and cylindrical surface 96. The user causes the 3″ coupling and in turn the entire reduction coupling 90 to rotate and in turn uncouple the reduction coupling 90 covered 5″ coupling (not shown).

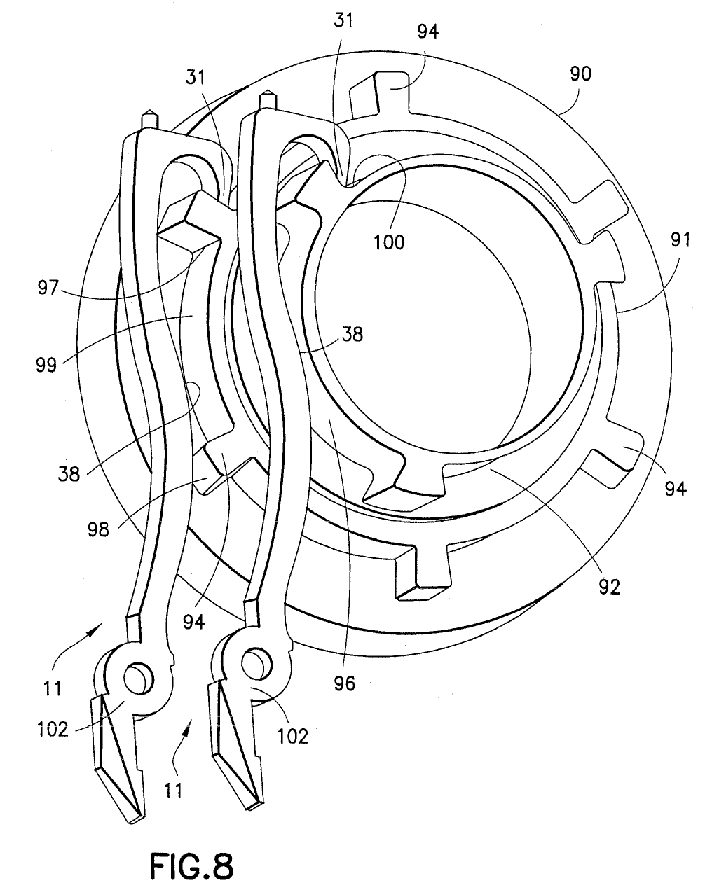

Referring now specifically to FIG. 8, there is shown a second embodiment of the present inventories. In this embodiment, member 11 itself is utilized as a fire hose uncoupling tool. Member 11 is shown in alternate operable engagement of the 5″ coupling portion 91 and the 3″ coupling portion 92. In the 3″ coupling portion 92 engagement, hook tip 31 engages recess formed between lug 94 and cylindrical surface 96 and transitional surface 38 contactingly engages cylindrical surface 96. The user grabs member 11 at the jaw and pivot surfaces 102 and exerts a downward force to cause rotation of reduction coupling 90. In the 5″ coupling portion 91 engagement, hook tip 31 fits into recess 100 and convex surface 37 contactingly engages the outer surface 98 of lug 94. Transitional surface 38 does not contactingly engage and is systematically disjoined from 5″ cylindrical surface 99. FIG. 8 demonstrates the use of one-piece unitary member 11 as a universal uncoupling tool.

It is understood and within the contemplation of the present invention to provide a one-piece unitary forged tool where a forged handle or ergonomic handle may be provided in lieu of the surfaces 102.

The other firefighter elements e.g. wrench 40, wedge 21, pin 16 and jaws 15 and 23 are used in the manner described in application Ser. No. 11/493,682, filed Jul. 26, 2006, published as Publ. No. ______, which application is incorporated herein in its entirety by references thereto.

While the present invention has been described by reference to a specific embodiment, it should be understood that modifications and variations of the invention might be constructed without departing from the scope of the invention as defined in the appended claims.

What is claimed is:

1. A firefighter tool comprising:
a member, said member comprises a first end and a second end, said first end comprises a grip portion, said second end comprises a hook, said hook extends from said second end towards said first end, said member further comprises a surface facingly disposed to said hook, said surface comprises a generally sinusoidal curvature, wherein a user grips the grip portion and engages a fire hose coupling with the hook contactingly engaged with one lug of the coupling and a portion of the sinusoidal curvature contactingly engaged with another part of the coupling, whereby the user exerts a force to cause the coupling to rotate.

2. The firefighter tool of claim 1, said hook comprises an end, and said hook end comprises a tip, and said tip engages a portion of the one lug.

3. The firefighter tool of claim 2, said generally sinusoidal curvature comprises a convex surface and a concave surface, and a transitional surface disposed between the convex and concave surfaces, and wherein the transitional surface contactingly engages the cylindrical surface of the fire hose coupling.

4. The firefighter tool of claim 3, said convex surface being disposed more adjacent the grip portion than the concave surface.

5. The firefighter tool of claim 2, said convex and concave surfaces comprise about equal radii of curvature.

6. A fire fighter tool comprising:
a first member and a second member, and means for pivotably connecting said members;
each said member comprises a first end and a second end, said first member second end comprises a hook, said hook extends from said second end towards said first end of said first member, said first member further comprises a surface facingly disposed to said hook, said surface comprises a generally sinusoidal curvature, wherein a user grips the second member only or portion of the first and second members and engages a fire hose coupling with the hook contactingly engaged with one lug of the coupling and a portion of the generally sinusoidal surface contactingly engaged with another part of the coupling, whereby the user exerts a force to cause the coupling to rotate.

7. The firefighter tool of claim 6, said sinusoidal curvature comprises a convex surface and a concave surface and a transitional surface disposed between the convex and concave surfaces.

8. The firefighter tool of claim 7, said convex and concave surfaces comprise about equal radii of curvature.

9. The firefighter tool of claim 6, said hook comprises an end, said end comprises a tip, and said tip engages said lug.

10. A firefighter tool comprising:
a first member comprising a proximately disposed first handle and a distally disposed first jaw;
a second member comprising a proximately disposed second handle and a distally disposed second jaw;
means for pivotably connecting the members comprising a pivot axis, and being disposed between the handles and jaws so that the handles pivotably move the jaws from an open position to a closed position;
a hook disposed at the proximate end of the second handle, said hook extends distally from the second handle proximate end, said hook being formed to contactingly to engage a first portion of a fire hose coupling, said second handle being formed with a generally sinusoidal curvature surface facingly disposed to said hook, said generally sinusoidal curvature surface contactingly engages a second portion of the fire hose coupling;
whereby the firefighter grips the tool and uses the hook to engage the fire hose coupling and the firefighter rotates the coupling to thereby uncouple the fire hose.

11. The firefighter tool of claim 10, said sinusoidal surface comprises a convex portion, a concave portion and a transitional portion disposed between the convex and concave portions.

12. The firefighter tool of claim 11, said convex and concave portions comprises about equal radii.

13. The firefighter tool of claim 12, said transitional surface is contiguous with the convex and concave surfaces, said transitional surface contactingly engages the fire hose coupling.

14. The firefighter tool of claim 11, said handles subtend an angle of at least about 70° with the jaws fully open.

15. The firefighter tool of claim 10, further comprising a wedge disposed at the proximate end of the first handle.

16. The firefighter tool of claim 15, said wedge comprises an elongate edge perpendicularly disposed to said pivot axis.

17. The firefighter tool of claim 10, said handle jaws comprise serrated surfaces disposed proximately of the pivot axis, said serrated surfaces being facingly disposed with the jaws closed.

18. The firefighter tool of claim 11, said transitional portion being disposed more adjacent the handle than the pivot axis.

19. The firefighter tool of claim 18, said convex and concave surfaces comprise about equal radii.

20. The firefighter tool of claim 19, said end face planar surface being contiguous with the rounded tip.

21. In combination:
(a) one of a fire hose reduction coupling or one of a plurality of fire hose couplings said couplings comprise at least a first coupling having a first diameter and a first plurality of radially disposed lugs, and a second coupling having a second diameter and a second plurality of radially disposed lugs; and
(b) a member, said member comprises a first end and a second end, said first end comprises a grip portion, said second end comprises a hook, said hook extends from said second end towards said first end, second member further comprises a surface facingly disposed to said hook, said surface comprises a generally sinusoidal curvature, wherein a user grips the grip portion and engages a fire hose coupling with the hook contactingly engaged with one lug of the coupling and a portion of the sinusoidal curvature contactingly engaged with another part of the coupling, whereby the user asserts a force to cause the coupling to rotate.

22. The combination of claim 21, said diameters are from about 1½ inches to about 5 inches.

23. The combination of claim 21, comprising:
said member comprises a first member, and further comprises a second member and means for pivotably connecting said members;
said first member comprises a first end and a second end, said first end comprises a grip portion, said second end comprises a hook, said hook extends from said second end towards said first end, said first member further comprises a surface facingly disposed to said hook, said surface comprises a generally sinusoidal curvature, wherein a user grips the grip portion and engages a fire hose coupling with the hook contactingly engaged with one lug of the coupling and a portion of the generally sinusoidal surface contactingly engaged with another part of the coupling, whereby the user asserts a force to cause the coupling to rotate.

24. The combination of claim 21, said generally sinusoidal surface comprises a convex surface, a concave surface and a transitional surface disposed between the convex and concave surfaces.

25. The combination of claim 24, said transitional surface being contiguous with the convex and concave surfaces, said transitional surface contactingly engages one of the fire hose coupling cylindrical surface and a lug, commensurate with the size and configuration of the coupling.

26. A firefighter tool comprising:
a member, said member comprising a first end and a second end, and a hook disposed at the rearward end and extends toward the first end; said member further comprises a generally sinusoidal surface facinqly disposed to said hook; whereby the user grips the first end and engages a fire hose coupling with the hook and a portion of the sinusoidal surface and exerts a torque in the coupling to cause the coupling to rotate.

27. The firefighter tool of claim 26, said sinusoidal surface comprises a convex surface, a concave surface and a transitional surface disposed between the convex and concave surfaces.

28. The firefighter tool of claim 27, the combination of claim 24, said transitional surface is contiguous with the convex and concave surfaces, said transitional surface contactingly engages one of the fire hose coupling cylindrical surface and a lug, commensurate with the size and configuration of the coupling.

29. The firefighter tool of claim 28, said member comprises one-piece unitary construction.

30. The firefighter tool of claim 26, the firefighter tool of claim 28, said member comprises a one-piece unitary construction.
